(19) United States
(12) Patent Application Publication
(10) Pub. No.: US 2008/0158616 A1
(43) Pub. Date: Jul. 3, 2008

(54) IMAGE FORMING SYSTEM

(75) Inventor: Tomoo KUDO, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA BUSINESS TECHNOLOGIES, INC., Tokyo (JP)

(21) Appl. No.: 11/872,600

(22) Filed: Oct. 15, 2007

(30) Foreign Application Priority Data
Dec. 27, 2006 (JP) JP2006-351505

(51) Int. Cl. H04N 1/36

(52) U.S. Cl. 358/424

(57) ABSTRACT

An image forming system including an image forming apparatus and a post-processing apparatus having: an image forming apparatus low-power transition time setting section for setting a low-power transition time of the image forming apparatus; a post-processing apparatus low-power transition time setting section for setting a low-power transition time of the post-processing apparatus; and an image forming communication section for transmitting information on the low-power transition time of the post-processing apparatus set by the post-processing apparatus low-power transition time setting section to the post-processing apparatus, and the post-processing apparatus having: a post-processing communication section for receiving the information on the low-power transition time of the post-processing apparatus transmitted from the image forming apparatus; and a post-processing controller for controlling a supply power to the post-processing apparatus on the basis of the information on the low-power transition time of the post-processing apparatus received by the post-processing communication section.

### RELATED APPLICATION

This application is based on Japanese Patent Application No. 2006-351505 filed on Dec. 27, 2006 in Japanese Patent Office, the entire content of which is hereby incorporated by reference.

### TECHNICAL FILED

The present invention relates to an image forming system and more particularly to an image forming system capable of performing the pasting bookbinding process.

### BACKGROUND OF THE INVENTION

An electrophotographic image forming apparatus is connected to a post-processing apparatus having a bookbinding section, thus it is finding more applications as an image forming system for executing from printing to bookbinding by one system.

As such a bookbinding section, a one using the case binding process of forming a booklet by coating an adhesive on the spine of a sheet bundle composed of printed sheets stacked and covering the sheet bundle with a cover sheet in a U shape is known.

And, a one, as power control for the system connected to the image forming apparatus and post-processing apparatus, according to the sheet processing mode set in the image forming apparatus, for turning on or off the power source of each unit (for example, a stacker unit for sorting sheets, a saddle unit for binding a bundle, a bookbinding unit, and a cutting unit) of the post-processing apparatus is known (for example, refer to Japanese Unexamined Patent Application Publication No. 2006-76218).

In such a system in which the post-processing apparatus capable of performing the pasting bookbinding process and the image forming apparatus are connected, to maintain high productivity, as an adhesive for adhering a booklet and a cover sheet, paste for completing adhesion in a short time is required and a hot melt adhesive has a characteristic that it is fused by heating and is set by cooling in a short time, so that, as mentioned above, it is preferably used for the pasting bookbinding process.

The bookbinding section of the sheet processing apparatus (post-processing apparatus) described in Japanese Unexamined Patent Application Publication No. 2006-76218 bundles sheets, then folds the sheets in two, thereby simply binds a booklet and as power control for the image forming apparatus and post-processing apparatus, uses the time settings relating to power control for the image forming apparatus and post-processing apparatus in common, thus even when performing a post process other than the bookbinding process, the bookbinding section of the post-processing apparatus may not be low-powered or shut off.

However, the hot melt adhesive, in addition to the aforementioned advantage, has a characteristic of being deteriorated due to prolonged heating, so that if the state that the bookbinding section is not low powered or shut off is continued long, the adhesive is deteriorated, thus a problem arises that there is a possibility that the bookbinding quality may be deteriorated such as defective adhesion between the sheet bundle and the cover sheet or separation of the cover sheet from the sheet bundle. To begin with, although the post process is not executed, unnecessary power is supplied to the post-processing apparatus, resulting in an increase in the power consumption.

### SUMMARY

On aspect of the present invention is as indicated below.

1. An image forming system including an image forming apparatus and a post-processing apparatus for performing a post process of sheets fed from the image forming apparatus, the image forming apparatus comprising: an image forming apparatus low-power transition time setting section for setting a low-power transition time of the image forming apparatus; a post-processing apparatus low-power transition time setting section for setting a low-power transition time of the post-processing apparatus; and an image forming communication section for transmitting information on the low-power transition time of the post-processing apparatus set by the post-processing apparatus low-power transition time setting section to the post-processing apparatus, and the post-processing apparatus comprising: a post-processing communication section for receiving the information on the low-power transition time of the post-processing apparatus transmitted from the image forming apparatus; and a post-processing controller for controlling a supply power to the post-processing apparatus on the basis of the information on the low-power transition time of the post-processing apparatus received by the post-processing communication section.

### BRIEF DESCRIPTION OF THE DRAWINGS

FIG. 1 is an entire schematic view of the image forming system having an image forming apparatus A and a post-processing apparatus B.

FIG. 2 is a cross sectional view of the post-processing apparatus B.

FIG. 3 is a cross sectional view of a sheet bundle conveying section 40 and an adhesive coating section 50.

FIG. 4 is a perspective view of the adhesive coating section 50 and a holding member 41.

FIG. 5 is a cross sectional view of the sheet bundle conveying section 40 and a cover sheet pasting section 80 when a sheet bundle Sa and a cover sheet K are adhered.

FIGS. 6(a) to 6(d) are cross sectional views of the cover sheet pasting section 80 and sheet bundle Sa indicating the folding step of the cover sheet K.

FIGS. 7(a) to 7(c) are perspective views showing the preparation process of a booklet Sb by the sheet bundle Sa and cover sheet K.

FIG. 8 is a time chart showing the power control for the image forming apparatus A and post-processing apparatus B.

FIGS. 9(a) and 9(b) are drawings showing examples of the low-power-shut-off transition time setting screen.

FIG. 10 is a block diagram showing the control for the image forming apparatus A and post-processing apparatus B.

FIG. 11 is a flow chart relating to the power control for the image forming apparatus A.

FIG. 12 is a flow chart relating to the power control for the post-processing apparatus B.

### DETAILED DESCRIPTION OF THE PREFERRED EMBODIMENT

The embodiment of the post-processing apparatus of the present invention and the image forming system having the post-processing apparatus will be explained with reference to the accompanying drawings, though the present invention is not limited to the embodiment.

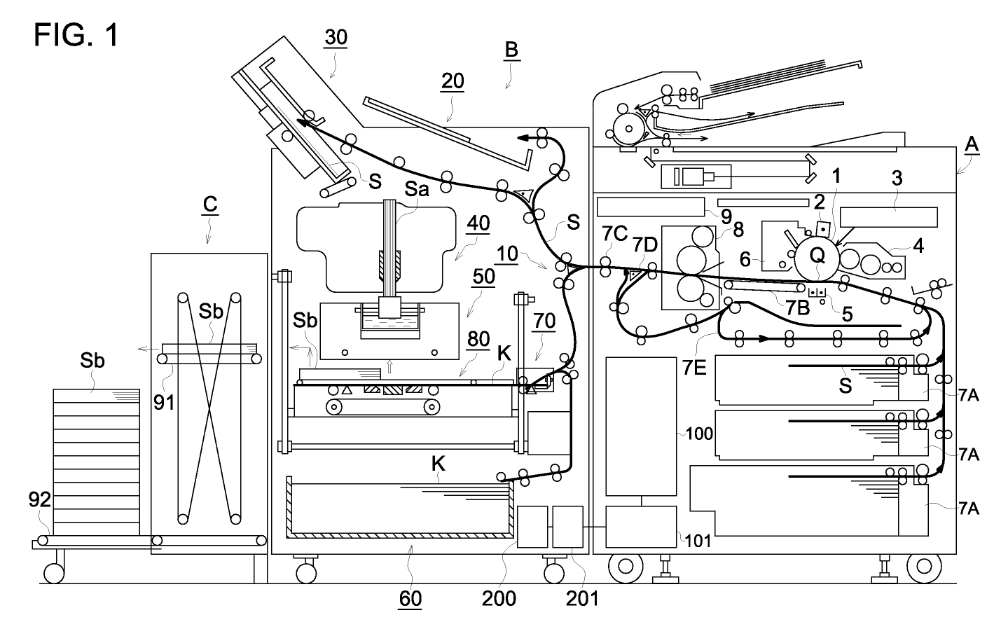

FIG. 1 is an entire schematic view of the image forming system having the image forming apparatus A and post-processing apparatus B.

The image forming system includes at least the image forming apparatus A and post-processing apparatus B.

Hereinafter, the image forming apparatus A and post-processing apparatus B composing the image forming system will be explained.

Image Forming Apparatus A

The image forming apparatus A has an image forming section, around a rotating image carrier 1, including a charger 2, an image exposure section 3, a developing section 4, a transfer and discharging section 5, and a cleaning section 6.

The image forming section charges uniformly the surface of the image carrier 1 by the charger 2, then performs exposure scanning based on image data read from a document by a laser beam of the image exposure section 3, thereby forms a latent image, reversely develops the latent image by the developing section 4, and forms a toner image on the surface of the image carrier 1.

A recording sheet (hereinafter referred to as a sheet) S which is a sheet fed from a sheet storing section 7A is sent to a transfer position Q. At the transfer position Q, the toner image is transferred onto the sheet S by the transfer and discharging section 5. The sheet S is discharged, is separated from the image carrier 1, is conveyed by a conveying section 7B, is fixed subsequently by a fixing section 8, and is ejected from sheet ejection rollers 7C.

The fixing section 8 includes a heating roller and a pressing roller that are not shown and the toner image is fixed on the sheet S by heat crimping on the contact surfaces of both rollers.

When forming images on both sides of the sheet S, the sheet S fixed by the fixing section 8 is branched from the ordinary sheet ejection path by a conveying path switching member 7D, is switched back by a reversely conveying section 7E to invert the front and rear thereof, then passes again through the image forming section, is formed an image on the rear thereof, and is ejected outside the apparatus from the sheet ejection rollers 7C via the fixing section 8. The sheet S ejected from the sheet ejection rollers 7C is sent to the post-processing apparatus B.

The surface of the image carrier 1 after image processing is removed a developer remaining on the concerned surface by the cleaning section 6 and is prepared for the next image formation.

Further, on the upper part of the image forming apparatus A, an operation section 9 equipped with, for example, a touch panel including an input member 91 and a display member 92 is arranged.

The image formation is carried out in this way, though the heat roller of the fixing section 8 has a characteristic of being deteriorated due to prolonged over-heating, so that by a main controller 100 for controlling the image forming apparatus, the image forming apparatus (the fixing section 8) is switched to the low-power state or shut-off state in a predetermined time after operation completion.

Here, the low-power state of the image forming apparatus indicates the power supply state of the power source of the heat roller that the temperature of the heat roller of the fixing section is lower than the ordinary fixing temperature (for example, 200° C.±10° C.) and equivalent to the temperature (for example, 110° C.±10° C.) at which the heat roller is hardly deteriorated and the shut-off state indicates the state that the power supply is cut off.

Further, the low-power transition time indicates the time from operation end of the image forming apparatus (fixing section) to transition to the low-power state and the shut-off transition time indicates the time from operation end of the image forming apparatus (fixing section) to transition to the shut-off state.

Further, in the image forming apparatus A, even in the shut-off state of the apparatus, a part of the members relating to the function of power control is supplied with standby power.

Post-Processing Apparatus B

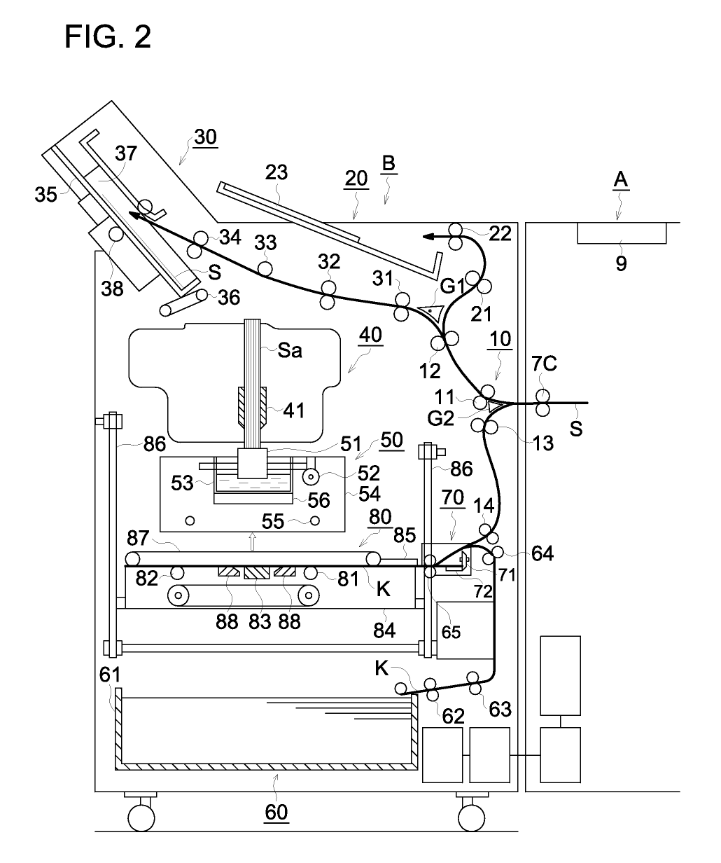

FIG. 2 is a cross sectional view of the post-processing apparatus B.

As shown in FIG. 1 or 2, the post-processing apparatus B relating to the present invention includes a sheet conveying section 10, a sheet ejection section 20, a sheet storing section 30, a sheet bundle conveying section 40, an adhesive coating section 50, a cover sheet feeding section 60, a cover sheet cutting section 70, and a cover sheet pasting section 80. These sections are arranged lengthwise almost in the vertical direction in the post-processing apparatus B.

Sheet Conveying Section 10

The sheet S introduced into the sheet conveying section 10 is held and conveyed between conveying rollers 11 and 12 and is branched to either of the sheet ejection section 20 and the sheet storing section 30 by a conveying path switching member G1.

A conveying path switching member G2 arranged on the upstream side of the conveying rollers 11 in the sheet conveying direction branches the sheet S ejected from the image forming apparatus A to either of the conveying path of the conveying rollers 11 and the conveying path of conveying rollers 13. The sheet S conveyed onto the conveying path of the conveying rollers 13 is held between conveying rollers 14 and is sent to the cover sheet pasting section 80.

Sheet Ejection Section 20

When the sheet conveyance is set, the conveying path switching member G1 cuts off the conveying path toward the sheet bundle conveying section 40 and opens the conveying path toward the sheet ejection section 20.

The sheet S passing through the conveying path of the sheet ejection section 20 is held between conveying rollers 21, is conveyed upward, and is ejected and stored on a fixed sheet receiving tray 23 on the uppermost part of the apparatus by sheet ejection rollers 22. The fixed sheet receiving tray 23 receives directly the sheet S ejected from the image forming apparatus A and can stack about 200 sheets at the maximum.

Sheet Conveying Section 30

The sheet S branched by the conveying path switching member G1 to the left on the drawing on the downstream side in the sheet conveying direction is held between conveying rollers 31, 32, 33, and 34, is stored at a predetermined position of the sheet storing section 30, and is stacked sequentially, thus a sheet bundle Sa composed of a predetermined number of sheets S is formed. The sheet storing section 30 includes a sheet loading table 35 arranged slantwise, a moving sheet trailing edge positioning member 36, a sheet width aligning member 37, and a sheet bundle conveying roller 38.

Sheet Bundle Conveying Section 40

The sheet S loaded on the sheet loading table 35 of the sheet storing section 30 is conveyed slantwise downward by a push-out member not drawn. Thereafter, the sheet S is held by a holding member 41 of the sheet bundle conveying section 40, is rotated so as to direct downward the surface (spine) of the sheet bundle Sa to be coated with an adhesive in the state that the sheet bundle Sa is held, and is stopped at a predetermined position.

Adhesive Coating Section 50

The adhesive coating section 50 includes an adhesive coating member (may be referred to as a coating roller) 51, a drive member 52 for driving the coating roller 52 to rotate, an adhesive container 53 for storing an adhesive, a moving section 54 for supporting the adhesive container 53 and moving from the initial position on the rear side of the post-processing apparatus B to the adhesive coating position on the front side, a moving member 55 for moving back and forth the moving section 54, and a heat member 56 for heating an adhesive N stored in the adhesive container 53.

The heat member 56 has a heater having a nichrome wire, which is controlled at a predetermined temperature by a finishing controller 200 for controlling the post-processing apparatus.

Further, the adhesive N has a characteristic that it is fused easily by heating and is set by cooling in a short time and an adherent mixture, which is solid at room temperature and is based on a thermoplastic polymer of 100% solid content, for example, a hot melt adhesive is used preferably.

Cover Sheet Feeding Section 60

A cover sheet K stored in a cover sheet stacking member 61 of the cover sheet feeding section 60 is separated and fed by a sheet feeding member 62, is held between conveying rollers 63, 64, and 65, and is conveyed to the cover sheet pasting section 80.

Cover Sheet Cutting Section 70

The cover sheet cutting section 70 integrally structured above the cover sheet feeding section 60 and on the right side of the cover sheet pasting section 80 which will be described later cuts off the cover sheet K in a predetermined length in the sheet conveying direction by a rotary cutter composed of rotary edge 71 and fixed edge 72.

The predetermined length is a length obtained by adding the length of the spine of the sheet bundle Sa to the length of two sheets S in the moving direction. For example, in the case binding process of pasting the cover sheet K on the spine of the sheet bundle Sa composed of the sheets S of A4 size, assuming the maximum number of sheets of the sheet bundle Sa as 300 and the thickness thereof as about 30 mm, the predetermined length is set to 450 mm obtained by adding a thickness of about 30 mm of the sheet bundle Sa to two times of a length of 210 mm of the short side of the A4-sixed sheets and the cover sheet K is cut off at one end. The total length of the cover sheet K before cutting is of a wide size longer than 450 mm.

Even when performing the case binding process for sheets S of the A5 size, B5 size, or 8.5×11 inch (one inch is 25.4 mm) size to prepare a booklet Sb, depending on the short side length of sheets and the thickness of a sheet bundle, the predetermined length is set.

By the operation section 9 of the image forming apparatus A, when the sheet size, number of sheets, and sheet thickness are selected and set or detected, the controller sets a predetermined cut length of the cover sheet K. The length of the cover sheet K before cutting is predetermined in correspondence with the maximum number of sheets and is stored in the cover sheet stacking member 61 of the cover sheet feeding section 60.

Cover Sheet Pasting Section 80

The cover sheet pasting section 80 includes conveying rollers 81 and 82 for receiving and conveying the cover sheet K fed from the cover sheet feeding section 60 and stopping it at a predetermined position, a pressurizing member 83 for pressurizing the cover sheet K to the adhesive coating surface of the sheet bundle Sa, a moving frame 84 for supporting the conveying rollers 81 and 82 and pressurizing member 83, an aligning member 85, and an elevating section 86 for moving the moving frame 84 in the vertical direction.

When the cover sheet pasting section 80 stops at the descending position and introduces the cover sheet K, the aligning member 85 moves from the initial position according to the size of the cover sheet K, compresses both sides of the cover sheet K in the width direction before cutting, thereby aligns the width. The cover sheet K which is aligned in the width and is corrected in the bend is switched back in the opposite direction of the introduction direction, is conveyed to the cover sheet cutting section 70, and is cut off at a predetermined position.

Further, before the cover sheet pasting section 80 adheres and joins the cover sheet K after cutting to the spine of the sheet bundle Sa at the descending position, the aligning member 85 moves again from the initial position, compresses both sides of the cover sheet K in the width direction, aligns the width, and stations the cover sheet K at a predetermined position. Thereafter, the aligning member 85 returns to its initial position so as to prevent obstacles to the junction of the cover sheet K to the sheet bundle Sa and then the cover sheet pasting section 80 moves up. During ascending, the cover sheet K is supported at the predetermined position.

Therefore, the aligning member 85 installed on the elevatable cover sheet pasting section 80 positions the cover sheet K in the width direction of the cover sheet before and after cutting by the cover sheet cutting section 70, thus improvement of the cover sheet cutting accuracy, improvement of the positioning accuracy of the sheet bundle Sa and cover sheet K, and simplification of the structure can be realized.

The elevating section 86, by rotating the left and right belts, moves the moving frame 84 to the upper position. At the ascending position, the central part of the cover sheet K loaded on the pressurizing member 83 is pressurized and adhered to the adhesive coating surface of the sheet bundle Sa. After end of the adhesive coating process to the sheet bundle Sa, the adhesive coating section 50 moves and retreats backward.

Cover Sheet Folding Process

On the upper part of the cover sheet pasting section 80, a cover sheet folding section is installed. The cover sheet folding section has a pair of molding members 88 symmetrical on the right and left. The molding members 88 are separable in the thickness direction of the sheet bundle Sa. The molding members 88 fold the cover sheet K along the side edge of the adhesive coating surface of the sheet bundle Sa and overlay the front cover sheet and back cover sheet on both sides of the sheet bundle Sa.

After end of the folding step of the cover sheet K, by the descending drive of the elevating section 86, the cover sheet pasting section 80 moves down and retreats at a predetermined distance and then an ejection belt 87 moves from the lower position of the booklet Sb, that is, the position equivalent to the outside of the booklet Sb in the width direction perpendicular to the conveying direction of the booklet Sb to the position equivalent to the inside thereof and stops. Thereafter, when the holding by the holding member 41 is canceled, the booklet Sb moves down and stops at the position where the lower spine of the booklet Sb makes contact with the top of the ejection belt 87.

The booklet Sb that the cover sheet K is pasted on the spine (the opposite side of the edge) of the sheet bundle Sa coated with adhesive and the front cover sheet and back cover sheet are formed is ejected to a booklet storing device C outside the apparatus by the ejection belt 87 arranged on the upper part of the aligning section 85.

Booklet Storing Device C

The booklet Sb ejected by the ejection belt 87 is loaded on an elevatable conveying belt 91 of the booklet storing device C shown in FIG. 1, is ejected sequentially by the rotation of the conveying belt 91, and is stacked and stored in a sheet ejection table 92.

With-Cover Sheet Bookbinding Step

Conveyance of Sheet Bundle and Cover Sheet

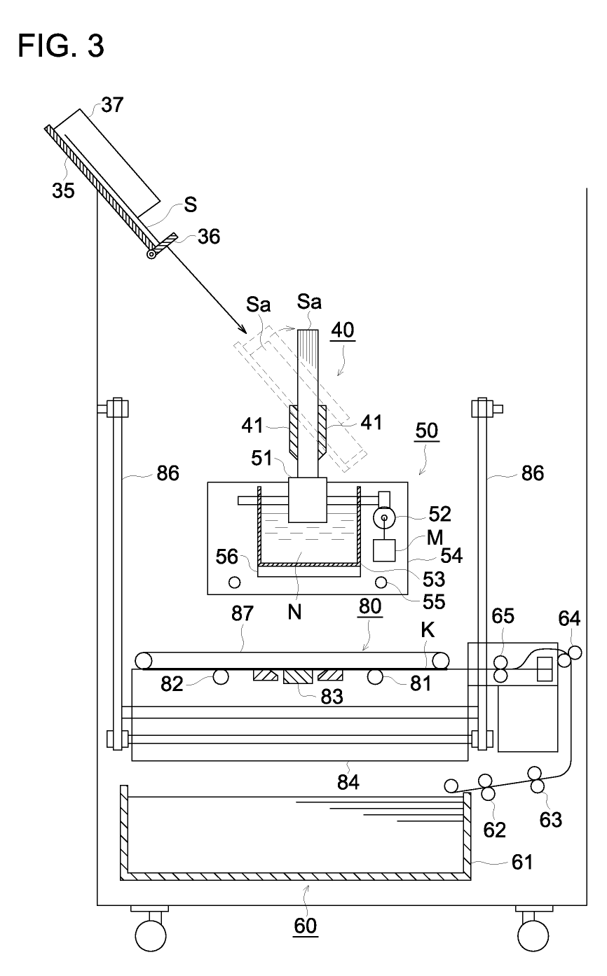

FIG. 3 is a cross sectional view of the sheet bundle conveying section 40 and adhesive coating section 50.

The sheets S loaded and aligned on the sheet loading table 35 of the sheet storing section 30 are held by the holding member 41. The sheet trailing edge positioning member 36 is rotated by a drive section not drawn and retreats under the sheet loading table 35. The holding member 41 holding the sheet bundle Sa moves slantwise downward as indicated by the dashed line drawn, then rotates, is held in the upright state so as to direct downward the surface of the sheet bundle Sa to be coated with an adhesive, and is stopped at a predetermined position.

On the other hand, the cover sheet K stored in the cover sheet stacking member 61 of the cover sheet feeding section 60 is separated and fed by the sheet feeding member 62, is held between the conveying rollers 63, 64, and 65, is conveyed by the conveying rollers 81 and 82 of the cover sheet pasting section 80, and is stopped at a predetermined position.

The cover sheet cutting section 70 arranged on the right side of the conveying rollers 65 in the drawing cuts off the cover sheet K in a predetermined length in the conveying direction thereof. Namely, the length of the cover sheet K in the conveying direction varies with the sheet size and the thickness of the sheet bundle Sa, so that the sheet size, number of sheets S, and thickness of the sheets S are inputted or detected beforehand, thus the wrapping length of the cover sheet K is calculated and prior to pasting of the cover sheet, the surplus portion of the cover sheet K is cut off to an optimum length by the cover sheet cutting section 70.

Adhesive Coating on Sheet Bundle

The moving section 54 of the adhesive coating section 50 is moved by a drive section not drawn in the direction parallel with the longitudinal direction of the bottom of the sheet bundle Sa held in the upright state by the holding member 41.

The moving section 54 starts movement from the initial position on the rear side of the post-processing apparatus B, is moved along the moving member 55, is stopped at a predetermined position on the front side of the post-processing apparatus B, and then is reversely driven to return to its initial position.

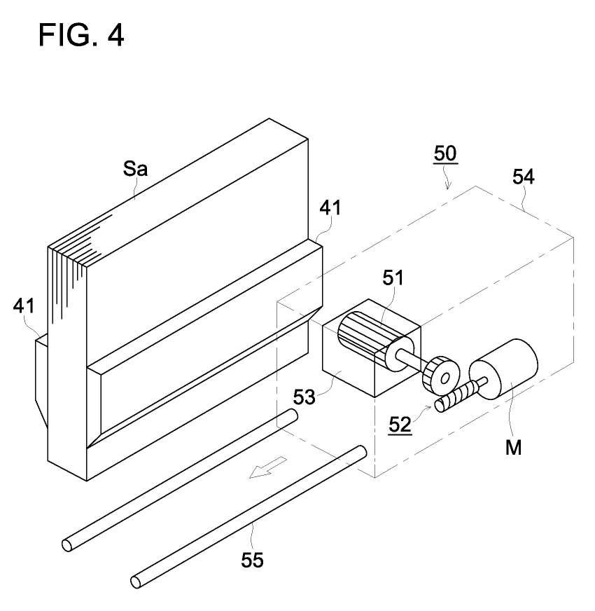

FIG. 4 is a perspective view of the adhesive coating section 50 and holding member 41.

By a motor M and the drive member 52, the coating roller 51 immersed in the adhesive container 53 storing the adhesive (paste) N is rotated. By the forward movement or backward movement of the moving section 54, the coating roller 51 coats the adhesive N on the bottom of the sheet bundle Sa held in the upright state in the longitudinal direction.

Adhesion of Sheet Bundle and Cover Sheet

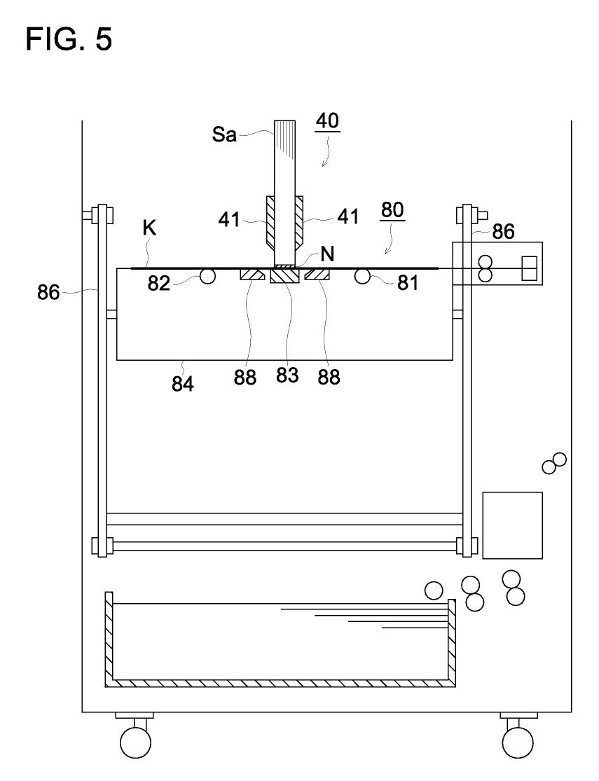

FIG. 5 is a cross sectional view of the sheet bundle conveying section 40 and cover sheet pasting section 80 when the sheet bundle Sa and cover sheet K are adhered.

After end of the adhesive coating step to the sheet bundle Sa, by a drive section not drawn, the elevating section 86 moves the moving frame 84 to the ascending position as a predetermined position. At the ascending position, the central part of the cover sheet K loaded on the pressurizing member 83 is pressurized and adhered to the adhesive coating surface of the sheet bundle Sa.

Folding Cover Sheet

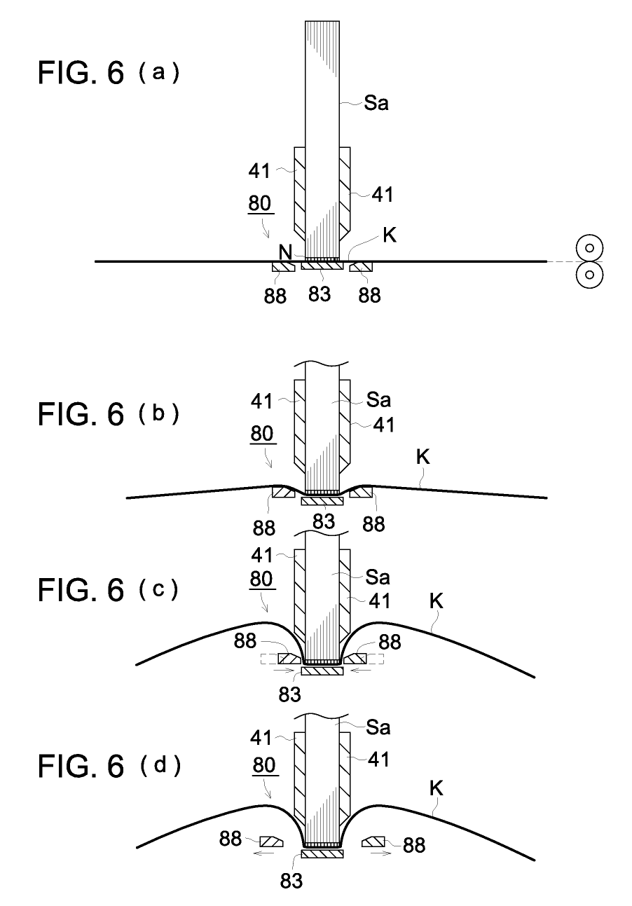

FIGS. 6(a) to 6(d) are cross sectional views of the cover sheet pasting section 80 and sheet bundle Sa indicating the folding step of the cover sheet K, and FIG. 6(a) shows the situation when the cover sheet folding starts, FIG. 6(b) the situation during folding the cover sheet, FIG. 6(c) the situation when the cover sheet folding ends, and FIG. 6(d) the situation when the folding pressure for the cover sheet is canceled.

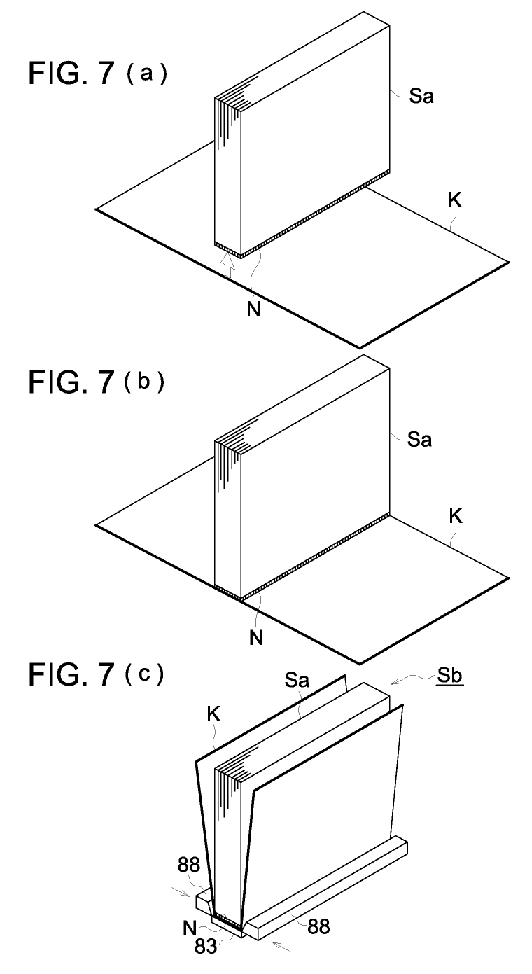

FIGS. 7(a) to 7(c) are perspective views showing the preparation process of the booklet Sb by the sheet bundle Sa and cover sheet K.

FIG. 7(a) is a perspective view of the cover sheet K and sheet bundle Sa in the state before the cover sheet pasting process is performed, FIG. 7(b) a perspective view of the sheet bundle Sa with the cover sheet K pasted, and FIG. 7(c) a perspective view of the booklet Sb prepared by wrapping-folding the cover sheet K over the sheet bundle Sa.

When the cover sheet K is adhered to the sheet bundle Sa with the adhesive N pasted and then the cover sheet pasting section 80 shown in FIGS. 6(a) to 6(d) moves up, the paired molding members 88 are driven by a drive section not drawn. The holding member 41 holding the sheet bundle Sa moves down. When the sheet bundle Sa moves down, the cover sheet K is held between the paired molding members 88 and moves down, thereby is curved from the side edge of the adhesive coating surface of the sheet bundle Sa (refer to FIG. 6(d)).

Thereafter, the paired molding members 88 moves horizontally toward the adhesive coating surface of the sheet bundle Sa, compresses and aligns both sides of the sheet bundle Sa, thereby forms the booklet Sb.

The case binding process is performed in this way, though as described above, the hot melt adhesive has a characteristic of being deteriorated due to prolonged heating, so that by the finishing controller 200 for controlling the post-processing apparatus, the case binding section (the adhesive coating section 50) of the post-processing apparatus is switched to the low-power state or shut-off state in a predetermined time after operation completion.

Here, the low-power state of the post-processing apparatus indicates the power supply state of the power source of the heat member 56 that the heating temperature of the heat member 56 of the adhesive coating section 50 is lower than the ordinary adhering temperature (for example, 145° C.±10° C.) and equivalent to the temperature (for example, 90° C.±10° C.) at which the adhesive is hardly deteriorated and the shut-off state indicates the state that the power supply is cut off.

The shut-off transition time indicates the time from operation end of the post-processing apparatus (the adhesive coating section 50) to transition to the shut-off state and the low-power transition time of the post-processing apparatus indicates the time from operation end of the post-processing apparatus (the adhesive coating section 50) to transition to the low-power state.

Further, in the post-processing apparatus B, even in the shut-off state of the apparatus, a part of the members relating to the function of power control is supplied with standby power.

Hereinafter, low power and shut off of the image forming apparatus and post-processing apparatus will be explained.

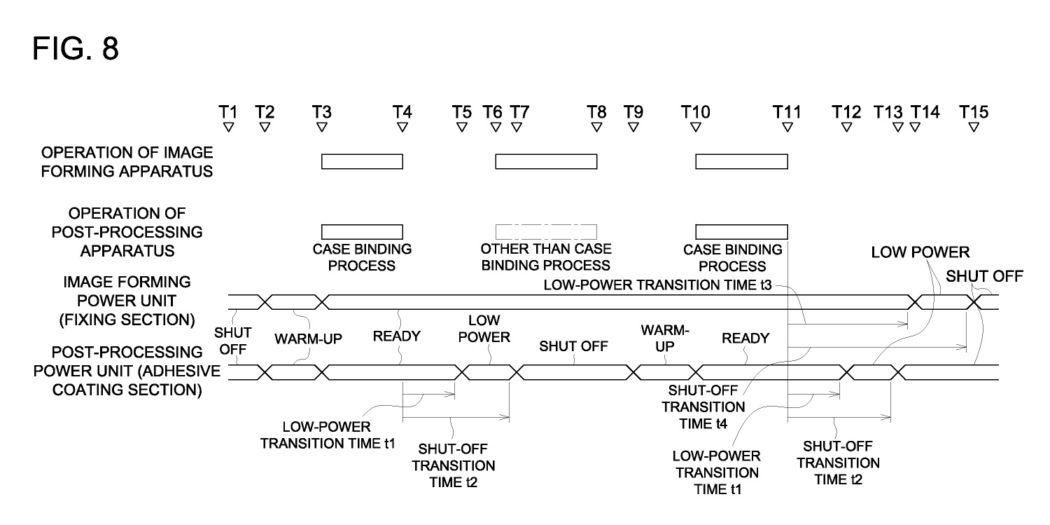

FIG. 8 is a time chart showing the power control for the image forming apparatus A and post-processing apparatus B.

Hereinafter, to provide easy understanding of low power and shut off of the present invention, the conditions of the power source for the image forming apparatus and post-processing apparatus when performing the case binding and when not performing it will be explained.

The transverse direction indicates the lapse of time.

Firstly, the case of case binding will be explained.

At timing T1, the image forming apparatus A and post-processing apparatus B are not in operation and the two are in the shut-off state.

At timing T2, by a start instruction for the image forming apparatus A and the post-processing apparatus B for which the case binding process is selected, the image forming apparatus A starts a warm-up of the fixing section and the post-processing apparatus B starts a warm-up of the heat member 56 of the adhesive coating section 50.

At timing T3, when the warm-ups of the two are completed, the image forming apparatus A and post-processing apparatus B (the adhesive coating section 50) start operation.

At timing T4, when a series of image forming and case binding processes is completed, the image forming apparatus A and post-processing apparatus B (the adhesive coating section 50) stop the operation.

At timing T5, the image forming apparatus A does not reach low-power transition time t3 and shut-off transition time t4, so that it is in the ready state that it can operate immediately by an image formation start instruction. And, when the post-processing apparatus B reaches low-power transition time t1, it is switched to the low-power state.

Next, the case of non-case binding (a post process other than case binding) will be explained.

At timing T6, by a start instruction for the image forming apparatus A and the post-processing apparatus B for which other than the case binding process (for example, the stacking process to the sheet storing section 30) is selected, the image forming apparatus A and post-processing apparatus B start an operation other than the case binding process.

Further, at this point of time, the case binding process is not selected, so that the adhesive coating section 50 of the post-processing apparatus B is kept in the low-power state.

At timing t7, when the adhesive coating section 50 of the post-processing apparatus B reaches the fourth predetermined time, the power supply to the adhesive coating section 50 is switched to the shut-off state.

At timing T8, when a series of image forming and case binding processes is completed, the image forming apparatus A and post-processing apparatus B stop the operation.

At timing T9, the case binding process is selected again, by a start instruction for the image forming apparatus A and post-processing apparatus B, the post-processing apparatus B starts a warm-up of the adhesive coating section 50.

At timing T10, when the warm-up of the post-processing apparatus B is completed, the image forming apparatus A and post-processing apparatus B (the adhesive coating section 50) start operation.

At timing T11, when the image forming apparatus A completes a series of image formation, the adhesive coating section 50 of the post-processing apparatus B, to complete the case binding process, completes and stops the operation slightly late.

At timing T12, the image forming apparatus A does not reach the low-power transition time t3 and shut-off transition time t4, so that it is in the ready state. And, when the post-processing apparatus B reaches the low-power transition time t1, it is switched to the low-power state.

At timing T13, when the adhesive coating section 50 of the post-processing apparatus B reaches a shut-off transition time t2, the power supply to the adhesive coating section 50 is switched to the shut-off state.

At timing T14, when the image forming apparatus A reaches the low-power transition time t3, it is switched to the low-power state.

At timing T15, when the image forming apparatus A reaches the shut-off transition time t4, it is switched to the shut-off state.

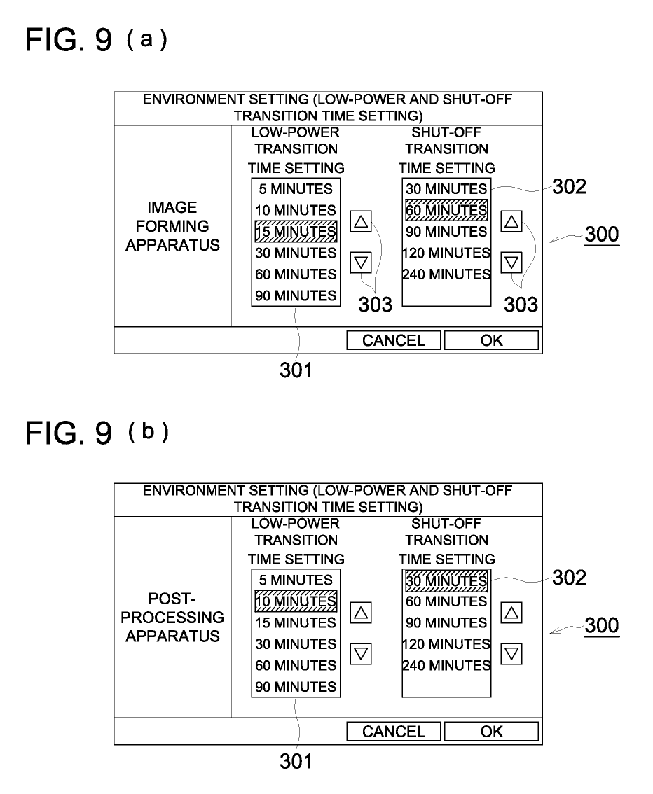

FIG. 9 shows drawings showing examples of the low-power-shut-off transition time setting screen.

By an environment setting screen display operation on a basic screen (not drawn), the main controller 100 permits the display member 92 to display a low-power-shut-off transition time setting screen 300 for setting the time until transition to the low-power state or shut-off state after end of the operation of the image forming apparatus and post-processing apparatus.

As a low-power-shut-off transition time setting screen 300, there are two low-power-shut-off transition time setting screens such as a one (a) for the image forming apparatus and a one (b) for the post-processing apparatus, and on each low-power-shut-off transition time setting screen, a plurality of low-power transition time setting portions 301 (for example, 5 minutes, 10 minutes, 15 minutes, - - - , 90 minutes), a plurality of shut-off transition time setting portions 302 (for example, 30 minutes, 60 minutes, 90 minutes, - - - , 240 minutes), and selection keys 303 of the low-power transition time and shut-off transition time are displayed, and the low-power transition time and shut-off transition time which are selected by the selection keys 303 are input to the main controller 100.

Here, (a) the low-power-shut-off transition time setting screen 300 for the image forming apparatus is equivalent to a low-power and shut-off transition time setting section of the image forming apparatus and (b) the low-power-shut-off transition time setting screen 300 for the post-processing apparatus is equivalent to a low-power and shut-off transition time setting section of the post-processing apparatus.

Further, the operation section 9 having a touch panel fulfills the functions of the input member 91 and display member 92.

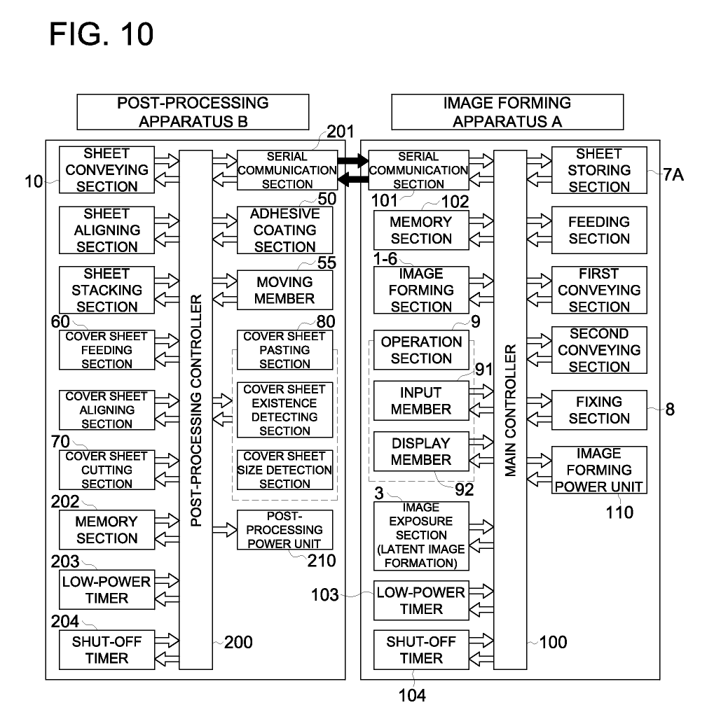

FIG. 10 is a block diagram showing the control for the image forming apparatus A and post-processing apparatus B.

Firstly, the constitution of the image forming apparatus A will be explained.

The image forming apparatus A includes the sheet storing section 7A aforementioned, a sheet feeding section, a first conveying section before the transfer process, a second conveying section after the transfer process, an image forming section, the fixing section 8, a memory section 203, the main controller 100, the operation section 9 composed of the input member 91 and display member 92, a serial communication section 101, a low-power timer 103, a shut-off timer 104, and an image forming power unit 110.

The image forming power unit 110 has a fixing heating power source (not shown) for supplying power to the fixing heating section for heating the heat member (heat roller) of the fixing section 8.

And, the program for executing the image formation is stored in a ROM (not shown) of the memory section 102 of the image forming apparatus, is loaded into the RAM at time of execution, and is executed by the main controller (image forming controller) 100 of the image forming apparatus A.

The operation section 9 displays the low-power-shut-off transition time setting screen 300 (FIG. 9) under the control of the main controller 100 and inputs the low-power transition time information and shut-off transition time information of the image forming apparatus and the low-power transition time information and shut-off transition time information of the post-processing apparatus which are selected by the low-power-shut-off transition time setting screen 300 to the main controller 100.

The low-power timer 103, under the control of the main controller 100, is activated by the operation end (job end) of the image forming apparatus and counts the time until reaching the low-power transition time t3.

The shut-off timer 104, under the control of the main controller 100, is activated by the operation end (job end) of the image forming apparatus and counts the time until reaching the shut-off transition time t4.

The image forming power unit 110, under the control of the main controller 100, supplies power to the concerned controller and switches the supply power to be supplied to a predetermined unit (for example, the fixing section 8) to the low-power state or shut-off state.

The main controller 100 compares the low-power transition time t3 of the image forming apparatus selected by the low-power-shut-off transition time setting screen 300 with the count time of the low-power timer 103 and when the two coincide with each other, permits the image forming power unit 110 to switch it to the low-power state. Further, the main controller 100 compares the selected shut-off transition time t4 of the image forming apparatus with the count time of the shut-off timer 104 and when the two coincide with each other, permits the image forming power unit 110 to switch it to the shut-off state.

The serial communication section 101, under the control of the main controller 100, transmits or receives information to or from the post-processing apparatus B via a serial communication section 201 of the post-processing apparatus B and transmits the low-power transition time information (t1) and shut-off transition time information (t2) of the post-processing apparatus to the post-processing apparatus.

Next, the constitution of the post-processing apparatus will be explained.

The post-processing apparatus B includes the sheet conveying section 10 aforementioned, a sheet aligning section, a sheet stacking section, the cover sheet feeding section 60, a cover sheet aligning section, the cover sheet cutting section 70, the adhesive coating section 50, the moving member 55 of the moving section 54 of the adhesive coating section 50, the cover sheet pasting section 80, the finishing controller 200, the serial communication section 201, the low-power timer 203, a shut-off timer 204, and a finishing power unit 210.

The finishing power unit 210 has an adhesive heating power source (not drawn) for supplying power to the adhesive heat member (heat member 56) for heating the adhesive N of the case binding section (the adhesive coating section 50).

And, the program for executing the finishing process is stored in a ROM (not shown) of a memory section 202 of the post-processing apparatus, is loaded into the RAM at time of execution, and is executed by the finishing controller 200 of the post-processing apparatus.

The serial communication section 201, under the control of the finishing controller 200, receives the low-power transition time information (t1) and shut-off transition time information (t2) of the post-processing apparatus transmitted from the image forming apparatus via the serial communication section 201 of the post-processing apparatus B.

The low-power timer 203, under the control of the finishing controller 200, is activated by the operation end (completion of adhesive coating of the adhesive coating section 50) of the post-processing apparatus and counts the time until reaching the low-power transition time t1.

The shut-off timer 204, under the control of the finishing controller 200, is activated by the operation end (completion of adhesive coating of the adhesive coating section 50) of the post-processing apparatus and counts the time until reaching the shut-off transition time t2.

The finishing power unit 210, under the control of the finishing controller 200, supplies power to the concerned controller and switches the supply power to be supplied to a predetermined unit (for example, the adhesive coating section 50) to the low-power state or shut-off state.

The finishing controller 200 compares the received low-power transition time t1 of the post-processing apparatus with the count time of the low-power timer 203 and when the two coincide with each other, permits the finishing power unit 210 to switch it to the low-power state. Further, the finishing controller 200 compares the received shut-off transition time t2 of the post-processing apparatus with the count time of the shut-off timer 204 and when the two coincide with each other, permits the finishing power unit 210 to switch it to the shut-off state.

Further, even in the shut-off state of the apparatus, a part of the members relating to the function of power control is supplied with standby power.

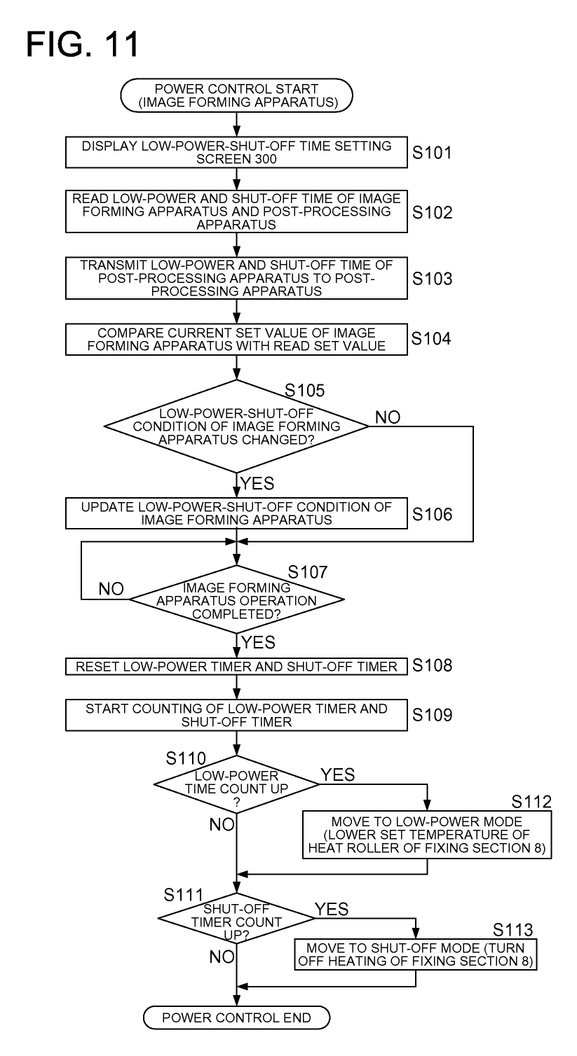

FIG. 11 is a flow chart relating to the power control for the image forming apparatus A.

The following control is executed by the main controller 100 of the image forming apparatus and is executed always as a subroutine of the program for controlling the whole image forming apparatus.

The main controller 100 displays the low-power-shut-off transition time setting screen 300 shown in FIGS. 9(a) and 9(b) on the display member 92 of the operation section 9 of the image forming apparatus (Step S101).

The main controller 100 reads the low-power transition time t3 (for example, 30 minutes) and shut-off transition time t4 (for example, 60 minutes) of the image forming apparatus and the low-power transition time t1 (for example, 15 minutes) and shut-off transition time t2 (for example, 30 minutes) of the post-processing apparatus which are set by the low-power-shut-off transition time setting screen 300 (Step S102).

The main controller 100 transmits the low-power transition time t1 (for example, 15 minutes) and shut-off transition time t2 (for example, 30 minutes) of the post-processing apparatus which are read to the post-processing apparatus B via the serial communication section 101 (Step S103).

The main controller 100 compares the low-power transition time t3 (for example, 15 minutes) and shut-off transition time t4 (for example, 60 minutes) of the image forming apparatus which are read with the low-power transition time t3′ (for example, 30 minutes) and shut-off transition time t4′ (for example, 90 minutes) of the image forming apparatus which are in use at present (Step S104).

As a result of comparison, when the two are different from each other (Yes), the main controller 100 goes to the next step and when the two are not different from each other, it jumps to Step S107 (Step S105).

The main controller 100 rewrites and updates the low-power transition time t3′ (for example, 30 minutes) and shut-off transition time t4′ (for example, 90 minutes) of the image forming apparatus which are in use at present to the low-power transition time t3 (for example, 15 minutes) and shut-off transition time t4 (for example, 60 minutes) of the image forming apparatus which are read (Step S106).

The main controller 100 monitors whether the image forming apparatus completes the operation (completion of image formation of one or a plurality of jobs) or not and waits for completion (Step S107).

When the image forming apparatus completes the operation, the main controller 100 resets the contents of the low-power timer and shut-off timer for counting the time required for the image forming apparatus to move to low power after operation completion to 0 (Step S108).

The low-power timer and shut-off timer start counting of the time (Step S109).

The main controller 100 monitors the low-power timer, decides whether the count reaches the low-power transition time t3 or not (count up), when the count reaches it (Yes), jumps to Step S112, and when the count does not reach it (No), goes to the next step (Step S110).

When the count reaches the low-power transition time t3, the image forming apparatus is moved to the low-power mode and the main controller 100 lowers the set temperature of the heat roller of the fixing section 8 (Step S112).

The main controller 100 monitors the shut-off timer, decides whether the count reaches the shut-off transition time t4 or not (count up), when the count reaches it (Yes), jumps to Step S113, and when the count does not reach it (No), goes to the next step (Step S111).

When the count reaches the shut-off transition time t4, the main controller 100 switches to the shut-off mode and turns off the power source of the post-processing apparatus (the heat roller of the fixing section 8) (Step S113).

As explained above, the power supplied to the heat roller of the fixing section 8 is switched to the low-power state after a lapse of the low-power transition time t3 and switched to the shut-off state after a lapse of the shut-off transition time t4, thus the deterioration with time due to heating by the heat roller of the fixing section 8 can be reduced.

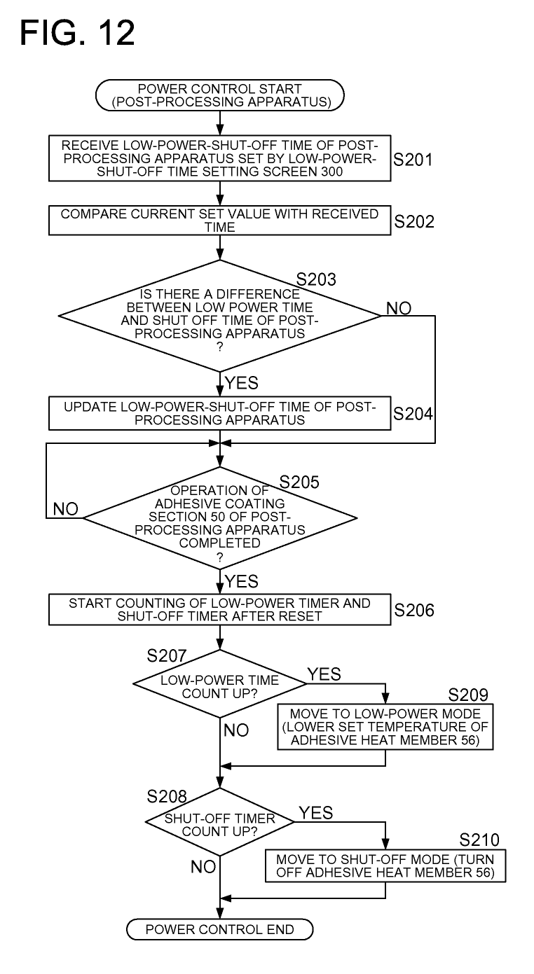

FIG. 12 is a flow chart relating to the power control for the post-processing apparatus B.

The following control is executed by the finishing controller 200 of the post-processing apparatus and is executed as a subroutine of the program for controlling the whole post-processing apparatus.

The finishing controller 200 receives the low-power transition time t1 (for example, 15 minutes) and shut-off transition time t2 (for example, 30 minutes) of the post-processing apparatus which are transmitted from the image forming apparatus A via the serial communication section 201 (Step S201).

The finishing controller 200 compares the low-power transition time t1 (for example, 15 minutes) and shut-off transition time t2 (for example, 60 minutes) of the post-processing apparatus which are received with the low-power transition time t1′ (for example, 30 minutes) and shut-off transition time t2′ (for example, 90 minutes) of the post-processing apparatus which are in use at present (Step S202).

As a result of comparison, when the two are different from each other (Yes), the finishing controller 200 goes to the next step and when the two are not different from each other, it jumps to Step S207 (Step S203).

The finishing controller 200 rewrites and updates the low-power transition time t1′ (for example, 30 minutes) and shut-off transition time t2′ (for example, 90 minutes) of the post-processing apparatus which are in use at present to the low-power transition time t1 (for example, 15 minutes) and shut-off transition time t2 (for example, 60 minutes) of the post-processing apparatus which are received (Step S204).

The finishing controller 200 monitors whether the post-processing apparatus completes the operation (completion of pasting of one or a plurality of jobs) or not and waits for completion (Step S205).

When the post-processing apparatus completes the operation, the finishing controller 200 resets the contents of the low-power timer and shut-off timer for counting the time required for the post-processing apparatus to move to low power after operation completion to 0 and the low-power timer and shut-off timer start counting of the time (Step S206).

The finishing controller 200 monitors the low-power timer, decides whether the count reaches the low-power transition time t1 or not (count up), when the count reaches it (Yes), jumps to Step S209, and when the count does not reach it (No), goes to the next step (Step S207).

When the count reaches the low-power transition time t1, the post-processing apparatus is moved to the low-power mode and the finishing controller 200 lowers the adhesive heating temperature of the adhesive coating section 50 (Step S209).

The finishing controller 200 monitors the shut-off timer, decides whether the count reaches the shut-off transition time t2 or not (count up), when the count reaches it (Yes), jumps to Step S210, and when the count does not reach it (No), goes to the next step (Step S208).

When the count reaches the shut-off transition time t2, the main controller 100 moves the image forming apparatus to the shut-off mode and turns off the power source of the post-processing apparatus (the heat member 56 of the adhesive coating section 50) (Step S210).

To provide easy understanding of the explanation, the post-processing apparatus having only the functions of the case binding process and the sheet stacking process onto the sheet storing section 30 is explained above as an example, though needless to say, the present invention can be applied to, for example, the case binding process of a post-processing apparatus including many functions such as the stapling process, folding process, punching process, cutting process, sheet stacking process, and case binding process.

As explained above, the power supplied to the heat member 56 of the adhesive coating section 50 is switched to the low-power state after a lapse of the low-power transition time t1 and switched to the shut-off state after a lapse of the shut-off transition time t2, thus the deterioration with time due to heating the adhesive N can be reduced.

Further, the low-power transition time t1 and shut-off transition time t2 of the post-processing apparatus and the low-power transition time t3 and shut-off transition time t4 of the image forming apparatus can be set individually, and the main controller 100 of the image forming apparatus switches to the low-power state and shut-off state on the basis of the low-power transition time t3 and shut-off transition time t4, thus the deterioration with time due to heating by the heat roller of the fixing section 8 can be reduced, and simultaneously, the finishing controller 200 of the post-processing apparatus switches to the low-power state and shut-off state on the basis of the low-power transition time t1 and shut-off transition time t2, thus the deterioration with time due to heating the adhesive N can be reduced, and simultaneously, compared with the case that the post-processing apparatus is continuously in the ready state, the power can be reduced.

Further, in the case binding process performed for sheets in large quantities, after image formation by the image forming apparatus, when the case binding process by the post-processing apparatus is continued for many hours, before a lapse of the low-power transition time t1 or shut-off transition time t2 of the post-processing apparatus, the count may reach the low-power transition time t3 or shut-off transition time t4 of the image forming apparatus and in such a case, compared with the case that the image forming apparatus is switched earlier to the low-power state or shut-off state and then is put into the ready state, the power can be reduced.

In this embodiment, the application of the present invention to the image forming system having the image forming apparatus capable of forming a monochromatic image and post-processing apparatus is explained, though the present invention can be applied to an image forming system having an image forming apparatus capable of forming a full-color image and a post-processing apparatus. Further, the post-processing apparatus is not limited to an apparatus for performing the case binding process, though when the present invention is applied to a post-processing apparatus having a section for fusing solid paste, particularly a high effect can be obtained.

What is claimed is:

1. An image forming system including an image forming apparatus and a post-processing apparatus for performing a post process of sheets fed from the image forming apparatus, the image forming apparatus comprising:
an image forming apparatus low-power transition time setting section for setting a low-power transition time of the image forming apparatus;
a post-processing apparatus low-power transition time setting section for setting a low-power transition time of the post-processing apparatus; and
an image forming communication section for transmitting information on the low-power transition time of the post-processing apparatus set by the post-processing apparatus low-power transition time setting section to the post-processing apparatus, and
the post-processing apparatus comprising:
a post-processing communication section for receiving the information on the low-power transition time of the post-processing apparatus transmitted from the image forming apparatus; and
a post-processing controller for controlling a supply power to the post-processing apparatus on the basis of the information on the low-power transition time of the post-processing apparatus received by the post-processing communication section.

2. The image forming system of claim 1, wherein the post-processing apparatus low-power transition time setting section enables setting of a low-power transition time of the post-processing apparatus that is shorter than a low-power transition time of the image forming apparatus set by the image forming apparatus low-power transition time setting section.

3. The image forming system of claim 1, wherein the image forming apparatus further comprises:
a fixing heating power source for supplying a power to a fixing heating section for heating a heating member of a fixing section;
an image forming controller for controlling a supply power by the fixing heating power source on the basis of the information on the low-power transition time of the image forming apparatus set by the image forming apparatus low-power transition time setting section.

4. The image forming system of claim 1, wherein the post-processing apparatus includes a post-processing apparatus low-power timer for counting the low-power transition time of the post-processing apparatus, and wherein the post-processing controller starts the post-processing apparatus low-power timer upon a termination of post-processing by the post-processing apparatus and then changes the power supply to the post-processing apparatus from a normal operating state to a low-power state based on a count of the post-processing apparatus low-power timer.

5. The image forming system of claim 1, wherein the image forming apparatus further comprises:
an image forming apparatus low-power timer for counting the low-power transition time of the image forming apparatus; and
an image forming controller which starts the image forming apparatus low-power timer upon a termination of a fixing process by a fixing section of the image forming apparatus and then changes the power supply to the fixing section from a normal operating state to a low-power state based on a count of the image forming apparatus low-power timer.

6. The image forming system of claim 1, wherein the post-processing apparatus is a bookbinding apparatus, which performs pasting operation to a bundle of sheets.

7. The image forming system of claim 1, wherein the image forming apparatus further comprises:
an image forming apparatus shut-off transition time setting section for setting a shut-off transition time of the image forming apparatus; and
a post-processing apparatus shut-off transition time setting section for setting a shut-off transition time of the post-processing apparatus;
wherein the image forming communication section is capable of transmitting the information on the shut-off transition time of the post-processing apparatus set by the post-processing apparatus shut-off transition time setting section;
the post-processing communication section is capable of receiving the information on the shut-off transition time of the post-processing apparatus transmitted by the image fuming communication section; and
the post-processing controller controls a supply power to the post-processing apparatus on the basis of the information on the shut-off transition time of the post-processing apparatus received by the post-processing communication section.

8. The image forming system of claim 7, wherein the post-processing apparatus shut-off transition time setting section enables setting of a shut-off transition time of the post-processing apparatus that is shorter than a shut-off transition time of the image forming apparatus set by the image forming apparatus shut-off transition time setting section.

9. The image forming system of claim 7, wherein the image forming apparatus further comprises:
a fixing heating power source for supplying a power to a fixing heating section for heating a heating member of a fixing section;
an image forming controller for controlling a supply power by the fixing heating power source on the basis of the information on the shut-off transition time of the image forming apparatus set by the image forming apparatus shut-off transition time setting section.

10. The image forming system of claim 7, wherein the post-processing apparatus includes a post-processing apparatus shut-off timer for counting the shut-off transition time of the post-processing apparatus, and wherein the post-processing controller starts the post-processing apparatus shut-off timer upon a termination of post-processing by the post-processing apparatus and then changes the power supply to the post-processing apparatus from a normal operating state to a shut-off state based on a count of the post-processing apparatus shut-off timer.

11. The image forming system of claim 7, wherein the image forming apparatus further comprises:
an image forming apparatus shut-off timer for counting the shut-off transition time of the image forming apparatus; and
an image forming controller which starts the image forming apparatus shut-off timer upon a termination of a fixing process by a fixing section of the image forming apparatus and then changes the power supply to the fixing section from a normal operating state to a shut-off state based on a count of the image forming apparatus shut-off timer.

12. The image forming system of claim 7, wherein the post-processing apparatus is a bookbinding apparatus, which performs pasting operation to a bundle of sheets.
